(19) United States
(12) Patent Application Publication
(10) Pub. No.: US 2012/0210646 A1
(43) Pub. Date: Aug. 23, 2012

(54) GATE RETRACTION DEVICE

(75) Inventors: Bob SHAW, Walbridge, OH (US); Jose Orland Araque, Louisville, KY (US)

(73) Assignee: INVENSYS RAIL CORPORATION, LOUISVILLE, KY (US)

(21) Appl. No.: 13/033,454

(22) Filed: Feb. 23, 2011

(51) Int. Cl. B61L 29/16; B61L 29/12; E01F 13/08; E05D 11/06; E05D 11/10; E05D 11/08; B61L 29/04; E05D 7/00

(52) U.S. Cl. 49/49; 16/382; 16/319; 16/349; 16/337; 49/506

(57) ABSTRACT

A device for permitting the (preferably manual) raising of a railroad crossing pedestrian arm independently of a roadway crossing arm, comprising a hinge including a first end operable to be connected to a pedestrian gate support arm and a second end operable to be connected to a pedestrian arm; wherein the hinge permits the second end to be raised by an external force relative to a position of the first end. Some embodiments further include a brake to slow movement of a manually raised pedestrian gate to a horizontal position.

### BACKGROUND

At many roadway railroad crossings, pedestrian paths and sidewalks also cross the railroad. Gates which are raised by default and lowered when a train approaches and crosses the intersection may be provided for roadway and pedestrian safety. There may be a separate gate for the roadway and the pedestrian path. This allows a pedestrian on the railroad tracks when the gates lower to manually raise a relatively light pedestrian gate, rather than a large and heavy roadway gate, to escape. At some intersections, the roadway gate and the pedestrian gate are raised and lowered by the same gate mechanism. The same internal gearing of the gate mechanism drives both gates. Therefore, when a pedestrian manually raises the pedestrian gate, the internal gearing of the gate mechanism raises the roadway gate as well. This can create an unsafe situation wherein a railroad crossing appears to be clear to motorists when a train is approaching. Some crossings use separate gate mechanisms for the roadway and pedestrian gates, but these are more expensive than single mechanism installations. Furthermore, single mechanism installations are already in place at countless railroad crossings, and replacing them with two-mechanism systems could be cost prohibitive for many railroad operators. A pedestrian gate which can be raised and lowered independently of a roadway gate using the same gate mechanism could inexpensively improve safety at railroad crossings, particularly if such a gate is suitable for new installations and retrofits.

### BRIEF DESCRIPTIONS OF THE DRAWINGS

FIG. 1 depicts a railroad crossing gate according to an embodiment of the invention.

FIG. 2 depicts a pedestrian gate support arm according to an embodiment of the invention.

FIG. 3 depicts a pedestrian arm according to an embodiment of the invention.

FIG. 4 depicts a hinge according to an embodiment of the invention.

FIG. 5 depicts a hydraulic brake assembly according to an embodiment of the invention.

FIG. 6A depicts a pedestrian gate according to an embodiment of the invention.

FIG. 6B depicts a pedestrian gate according to an embodiment of the invention.

FIG. 7 depicts a friction brake assembly according to an embodiment of the invention.

FIG. 8A depicts a pedestrian gate according to an embodiment of the invention.

FIG. 8B depicts a pedestrian gate according to an embodiment of the invention.

### DETAILED DESCRIPTION

While the following embodiments are discussed in the context of railroad crossing gates, it will be understood that this is for example only, and the scope of this disclosure is not limited to the railroad field. Access control gates can be used in a wide variety of devices and fields. Furthermore, while the following embodiments may be presented for use with specific pedestrian crossing gate systems, these are also presented as examples to provide greater understanding of the disclosure to those of ordinary skill in the relevant arts. Also, while some method steps are delineated as separate steps for ease of understanding, any such steps should not be construed as necessarily distinct nor order dependent in their performance.

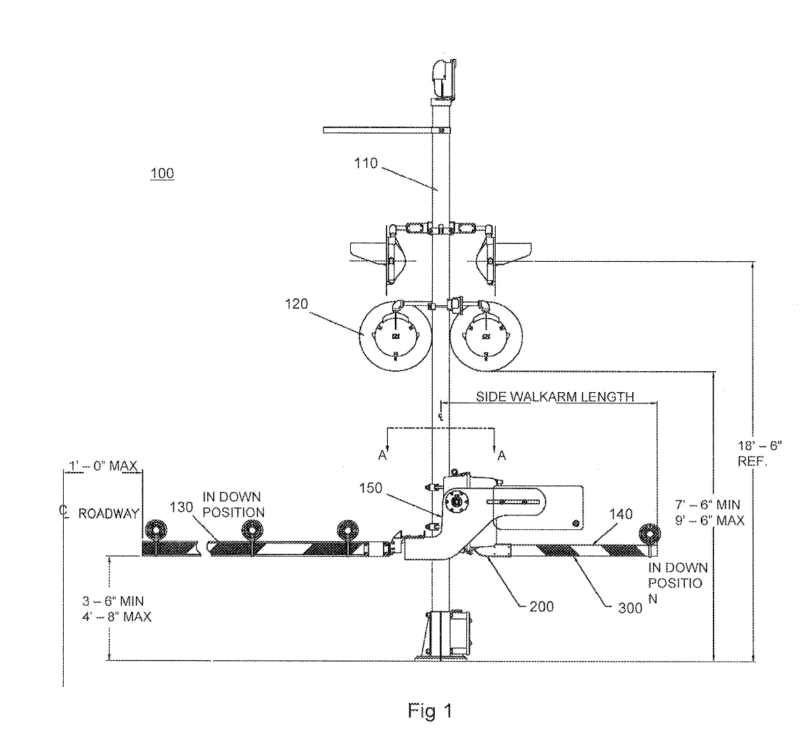

FIG. 1 depicts a railroad crossing gate 100 in a lowered position. The example railroad crossing gate 100 includes a pole 110, signal lights 120, and a gate mechanism 150 to raise and lower gates 130 and 140. The railroad crossing gate 100 may be placed at a roadway railroad crossing. When a train approaches the crossing, the railroad crossing gate 100 may signal using the signal lights 120 and lower its gates 130 and 140 to restrict traffic from crossing the tracks until the train has passed. At many crossings, at least one railroad crossing gate 100 may be placed on either side of the railroad track to restrict road traffic in both directions. At some crossings, pedestrian paths or sidewalks may run parallel to the roadway. To restrict road and sidewalk traffic, the railroad crossing gate 100 may include a separate roadway gate 130 and pedestrian gate 140. The roadway gate 130 and pedestrian gate 140 may be raised and lowered by the same gate mechanism 150. The pedestrian gate 140 may include a pedestrian gate support arm 200 connecting the gate 140 to the gate mechanism 150 and a pedestrian arm 300 which restricts sidewalk traffic when lowered. When raised, gates 130 and 140 may be positioned so that they do not interfere with either roadway or pedestrian traffic.

Occasionally, pedestrians using the sidewalk at a railroad crossing may find themselves on the railroad tracks when the roadway gate 130 and the pedestrian gate 140 are lowered. When a pedestrian gate 140 is placed on both sides of the railroad track to restrict entry in both directions, the pedestrian may have to manually raise one of the pedestrian gates 140 to get off the tracks before a train arrives. For railroad crossing gates 100 with single gate mechanisms 150, manually raising the pedestrian gate 140 may also raise the roadway gate 130, because both gates may be driven by the same internal gearing within the gate mechanism 150. Likewise, if a pedestrian manually raises the pedestrian gate 140 while the gate mechanism 150 is lowering the gates, the lowering operation may be interrupted and both gates may be raised rather than being driven to their lowered positions.

Embodiments of the invention may include a hinge on the pedestrian gate 140 to allow a pedestrian to manually raise the pedestrian gate 140 without interfering with the roadway gate 130. A brake may also be provided so that when a pedestrian raises the pedestrian gate 140, its descent back to its starting position may be slowed. In some embodiments of the invention, the hinge and brake may be disposed between the pedestrian gate support arm 200 and the pedestrian arm 300. This location may allow the hinge and brake to be retrofitted into existing railroad crossing gates 100 with minimal disassembly, and it may also be compatible with new railroad crossing gate installations.

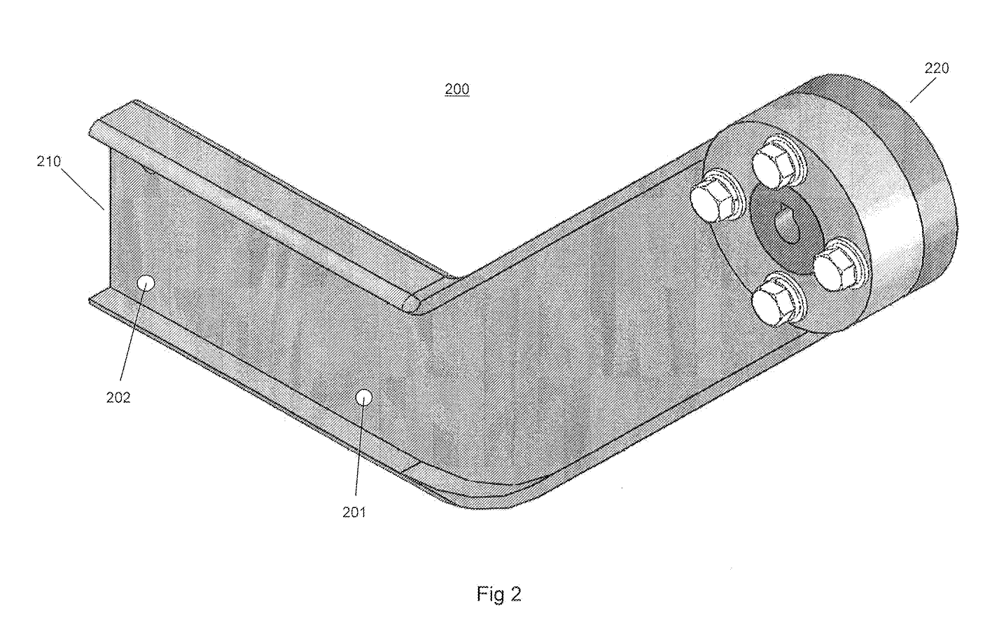

FIG. 2 depicts a pedestrian gate support arm 200 according to an embodiment of the invention. The pedestrian gate support arm 200 may have an outer end 210 and an inner end 220. The inner end 220 may connect to the gate mechanism 150, allowing the pedestrian gate support arm 200 to be raised and lowered by the gate mechanism 150. The outer end 210 may include one or more attachment positions (201 and 202 in this example) for attachment of a pedestrian arm 300 or a hinge and brake.

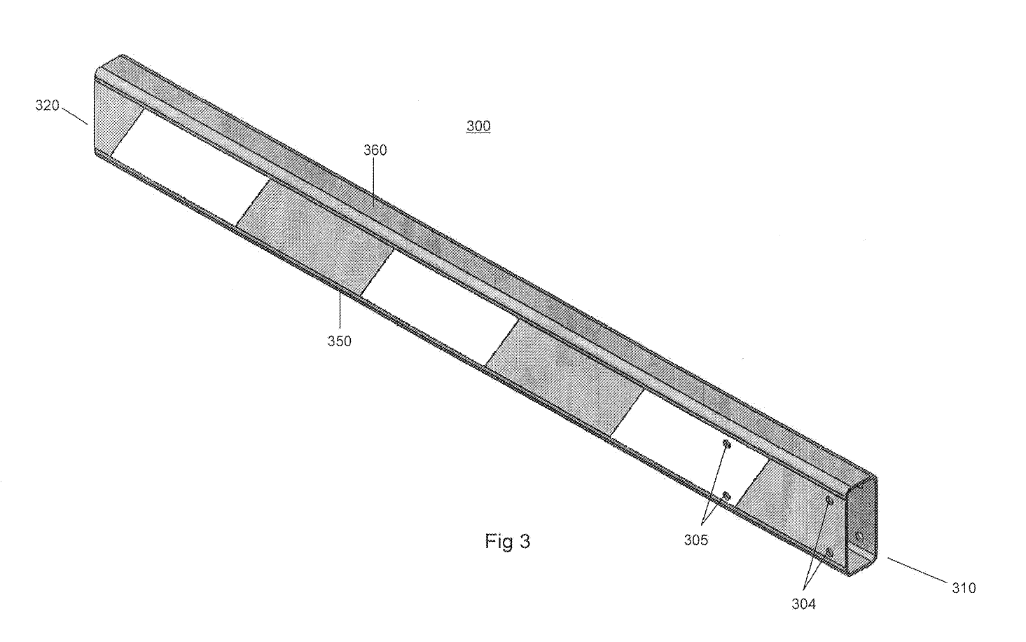

FIG. 3 depicts a pedestrian arm 300 according to an embodiment of the invention. The pedestrian arm 300 may be of any length necessary to obstruct a pedestrian path when lowered. In many installations this length may be 12 feet or less, but larger pedestrian arms 300 are within the scope of the invention. The pedestrian arm 300 may have an inner end 310 and an outer end 320. The inner end 310 may include one or more attachment positions (304 and 305 in this example) for attachment to a pedestrian gate support arm 200 or a hinge and brake. The pedestrian arm 300 may have a lower side 350 which may face the ground when the pedestrian arm 300 is in any position other than a fully open position, such as when the pedestrian arm 300 is being lowered or raised or is fully lowered. The pedestrian arm 300 may also have an upper side 360 opposite the lower side 350.

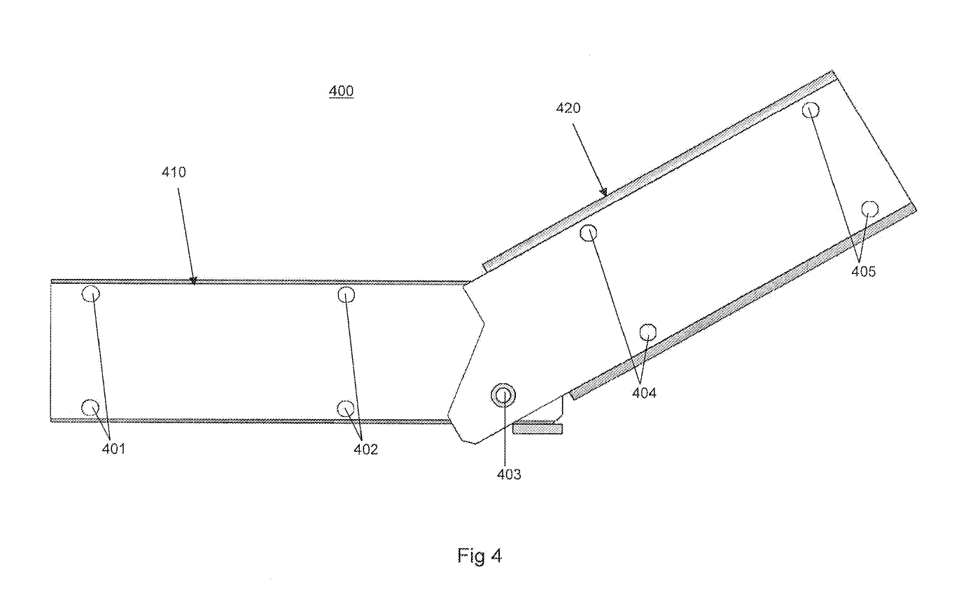

FIG. 4 depicts a hinge 400 according to an embodiment of the invention. This hinge 400 is presented as an example, but no specific hinge design is necessary, and other embodiments may use other hinges. The hinge 400 may pivot about a pivot point 403. A first end 410 may be attached to the pedestrian gate support arm 200, and a second end 420 may be attached to the pedestrian arm 300. Attachment positions on the first end (401 and 402 in this example) may correspond to the attachment positions on the pedestrian gate support arm 200, and attachment positions on the second end (404 and 405 in this example) may correspond to the attachment positions on the pedestrian arm 300. When the hinge 400 is attached to the pedestrian gate support arm 200 and the pedestrian arm 300, a pedestrian may lift the pedestrian arm 300 and cause the hinge 400 to rotate at its pivot point 403. The pedestrian gate support arm 200 may continue to lower or remain lowered even as the pedestrian arm 300 is raised. Therefore, the internal operation of the gate mechanism 150 may be unaffected and the roadway gate 130 may continue to lower or remain lowered. Also, after the upward force on the pedestrian arm 300 is removed, the pedestrian arm 300 may continue to lower or proceed to its lowered state.

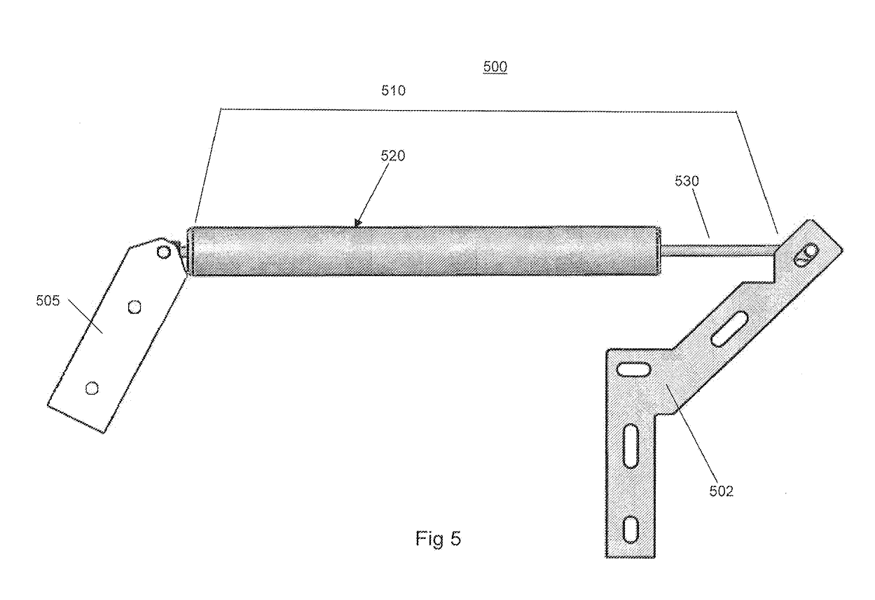

Embodiments of the invention may provide a brake to slow the lowering of the pedestrian arm 300 after the upward force is removed. Slowing the pedestrian arm 300 may provide more time for a pedestrian to proceed through the crossing and may prevent damage or injury caused by a quickly falling pedestrian arm 300. FIG. 5 depicts a hydraulic cylinder brake 500 according to an embodiment of the invention. A hydraulic cylinder 510 having a cylinder body 520 and a piston rod 530 may be attached to a first bracket 502 and a second bracket 505. These attachments may pivot to prevent bending of any part of the hydraulic cylinder 510. In this example, the cylinder body 520 is attached to the second bracket 505 and the piston rod 530 is attached to the first bracket 502. A piston inside the hydraulic cylinder 510 may allow the piston rod 530 to move into and out of the cylinder body 520 when the distance between the brackets 502 and 505 changes. The first bracket 502 may be attached to an attachment position or positions on the pedestrian gate support arm 200 and/or the first end 410 of the hinge 400, and the second bracket 505 may be attached to an attachment position or positions on the pedestrian arm 300 and/or the second end 420 of the hinge 400.

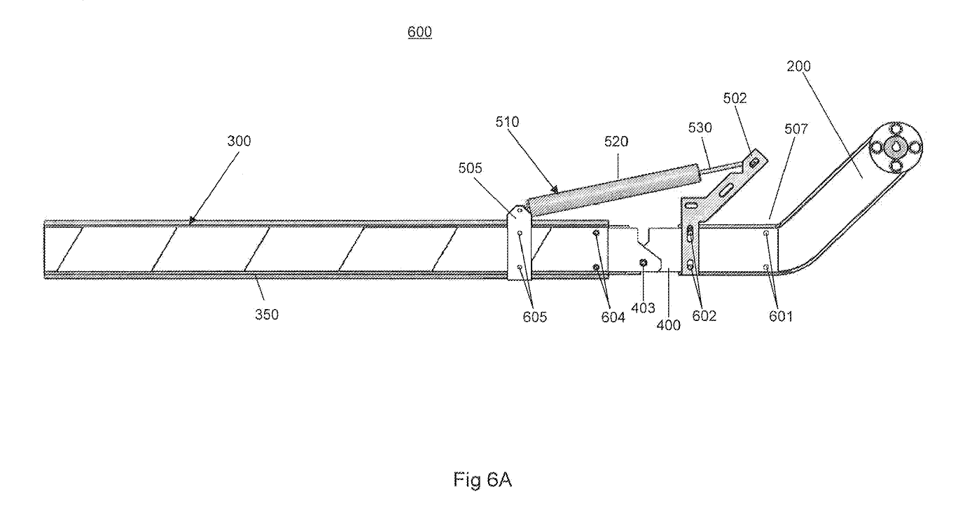

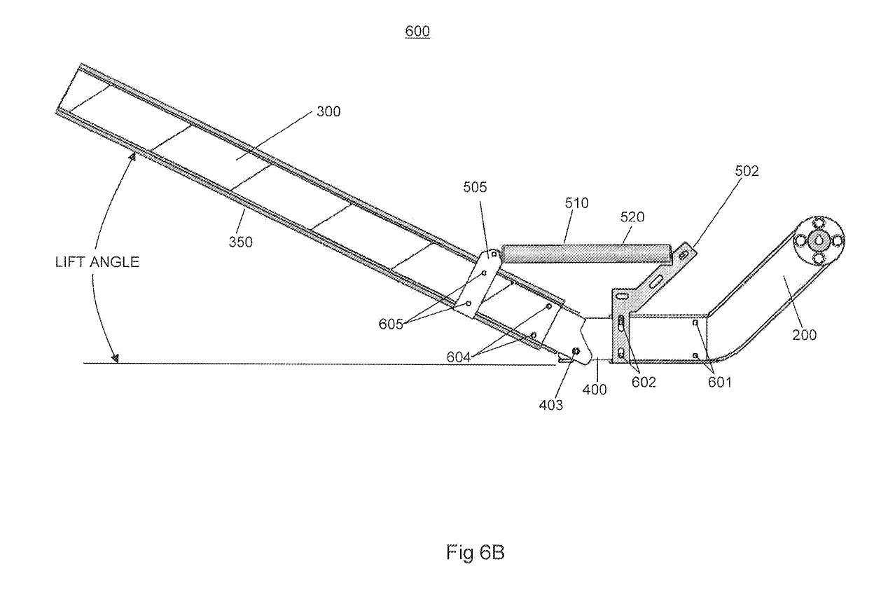

FIGS. 6A and 6B illustrate a pedestrian gate 600 including a hinge 400 and hydraulic brake 500 according to an embodiment of the invention. Corresponding attachment positions on the pedestrian gate support arm 200 and the hinge 400 may be aligned at attachment positions 601 and 602. The pedestrian gate support arm 200 and the hinge 400 may be attached at these attachment positions with fasteners such as screws, bolts, or other hardware; or they may be attached through welding or adhesives; or by any other technique or device. Similarly, the pedestrian arm 300 and the hinge 400 may be aligned at attachment positions 604 and 605 and attached to one another using the same or different technique or device as the pedestrian gate support arm 200 and the hinge 400. The first bracket 502 of the hydraulic brake 500 may be attached to the pedestrian gate support arm 200 and the hinge 400 at one of the attachment positions (602 in this example). The first bracket 502 may be attached to the pedestrian gate support arm 200 and the hinge 400 using the same hardware joining the pedestrian gate support arm 200 and the hinge 400, or it may be attached in a different way. The second bracket 505 of the hydraulic brake 500 may be attached to the pedestrian arm 300 and the hinge 400 at one of the attachment positions (605 in this example). The second bracket 505 may be attached to the pedestrian arm 300 and the hinge 400 using the same hardware joining the pedestrian arm 300 and the hinge 400. Those of skill in the art will understand that the hydraulic brake 500 may be attached to in any number of ways, so long as opposite ends of the hydraulic brake 500 are attached on opposite sides of the pivot point 403 of the hinge 400. For example, the hydraulic brake 500 may be attached to the hinge 400 at both ends, or to the hinge 400 at one end and either the pedestrian gate support arm 200 or the pedestrian arm 300 at the other end, or to the pedestrian gate support arm 200 at one end and the pedestrian arm 300 at the other end, etc. The hydraulic cylinder 510 of the hydraulic brake 500 may be sufficiently pressurized so that the hinge 400 does not pivot due to the forces of wind or gravity on the pedestrian arm 300 when the pedestrian gate 600 is in an open position.

FIG. 6A shows a pedestrian gate 600 that has been fully lowered by the gate mechanism 150 according to an embodiment of the invention. The pedestrian arm 300 in its lowered position may extend over a pedestrian path at a height low enough to obstruct traffic. When no force is being applied to the lower side 350 of the pedestrian arm 300 (or when no pulling force is being applied to the upper side 360), the piston rod 530 of the hydraulic brake 500 may be fully extended. Depending on the embodiment of the invention, a “fully extended” piston rod 530 may be extended as far as the hydraulic cylinder 510 will allow or some lesser amount dictated by a maximum open angle of the hinge 400 (180 degrees in the example of FIG. 6A).

FIG. 6B shows a pedestrian gate 600 that has been fully lowered by the gate mechanism 150 according to an embodiment of the invention. In FIG. 6B, a force is being applied (or has recently been applied) to the lower side 350 (or the upper side 360) of the pedestrian arm 300. This force may be a pedestrian lifting the gate, an obstacle standing in the way of the gate, or some other force. This force may cause the hinge 400 to rotate and the pedestrian arm 300 to raise. Because the hinge 400 rotates in response to this force, the pedestrian gate support arm 200 may retain its position in spite of the application of the force. Note that the pedestrian gate support arm 200 is in the same position in both FIGS. 6A and 6B, while the pedestrian arm 300 is in a different position in each figure. When a force is applied to the pedestrian arm 300, the pedestrian arm 300 may be raised without affecting the pedestrian gate support arm 200 at least until the piston rod 530 of the hydraulic brake 500 is fully retracted. Depending on the embodiment of the invention, a “fully retracted” piston rod 530 may be retracted as far as the hydraulic cylinder 510 will allow or some lesser amount dictated by a minimum open angle of the hinge 400.

When the force applied in FIG. 6B is removed, the pedestrian arm 300 may return to its position in FIG. 6A. The hydraulic brake 500 may slow the return of the pedestrian arm 300 to its lowering, raising, or lowered position corresponding with the position of the pedestrian gate support arm 200 and fully open hinge 400. Pressurized fluid within the hydraulic cylinder 310 may slow the extension of the piston rod 530, which in turn may counteract the force of gravity to reduce the acceleration rate of the pedestrian arm 300. By slowing the return of the pedestrian arm 300, injury or damage to a pedestrian or object under the pedestrian arm 300 may be minimized or prevented.

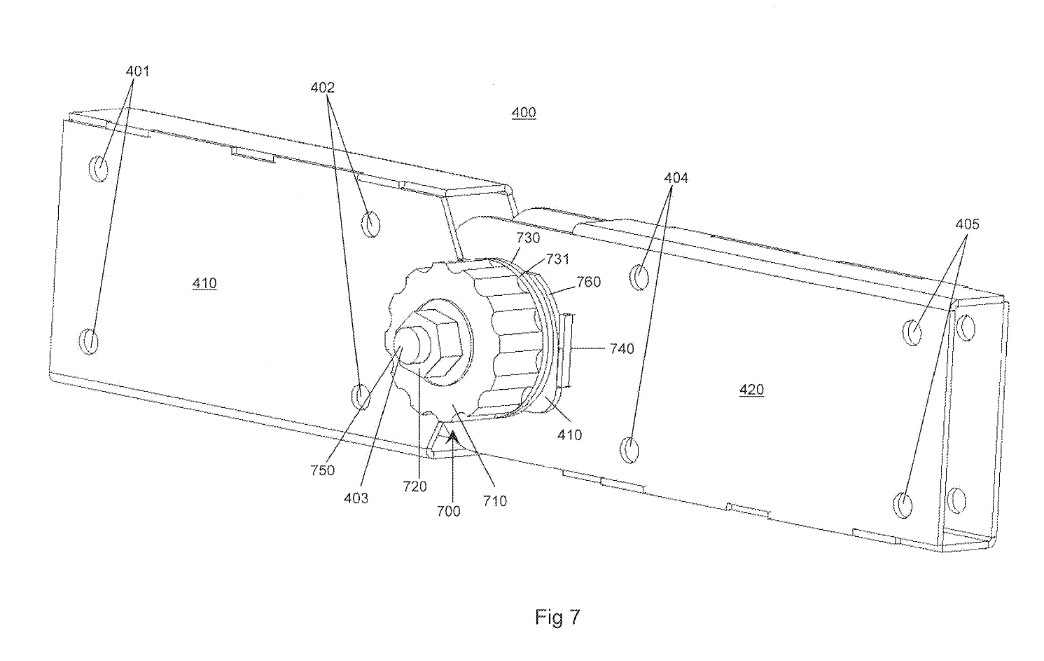

FIG. 7 depicts a hinge 400 and friction brake 700 according to an embodiment of the invention. A friction brake 700 may be provided to slow the lowering of the pedestrian arm 300 after the upward force is removed in some embodiments. As with the hinge 400 of FIG. 4, the hinge 400 of FIG. 7 may pivot about a pivot point 403. A first end 410 may be attached to the pedestrian gate support arm 200, and a second end 420 may be attached to the pedestrian arm 300. Attachment positions on the first end (401 and 402 in this example) may correspond to the attachment positions on the pedestrian gate support arm 200, and attachment positions on the second end (404 and 405 in this example) may correspond to the attachment positions on the pedestrian arm 300.

The friction brake 700 may include friction pads, such as a first friction pad 730 and a second friction pad 731 which may slow the movement of the second end 420 of the hinge 400 with respect to the first end 410 of the hinge 400 by converting the kinetic energy of the second end 420 into heat. The friction pads 730 and 731 may be made from different materials having different coefficients of friction or they may be made of the same material. An adjusting knob 710 may allow a user to adjust a force with which the friction pads 730 and 731 are pressed together. A rod 750 may be located at the pivot point 403. This rod 750 may be rigidly attached to the second end 420 or it may be an integral part of the second end 420. The rod 750 may pass through holes in the first end 410, the adjusting knob 710, and the friction pads 730 and 731. A nut 720 may be provided to secure the second end 420, the adjusting knob 710, and the friction pads 730 and 731 around the rod 750. One friction pad 731 may be attached to the rod 750, and the other friction pad 730 may be attached to the first end 410. A tab 740 may be disposed on the second end 420 near an edge 760 of the first end 410. The tab 740 and edge 760 may be shaped such that the tab 740 may restrict the movement of the second end 420 about the pivot point 403 by blocking its progress in moving beyond a set position. In some embodiments the tab 740 and edge 760 may block the progress of the second end 420 in moving beyond two positions in opposite directions. The embodiment of FIG. 7 is presented as an example, but other friction brake and hinge configurations are possible. For example, the first end 410 may be attached to the pedestrian gate support arm 200, and the second end 420 may be attached to the pedestrian arm 300.

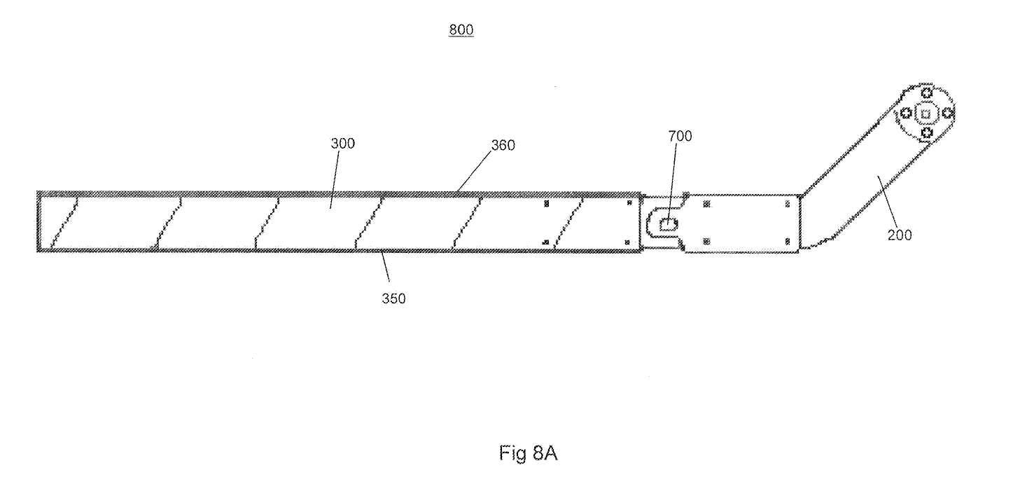

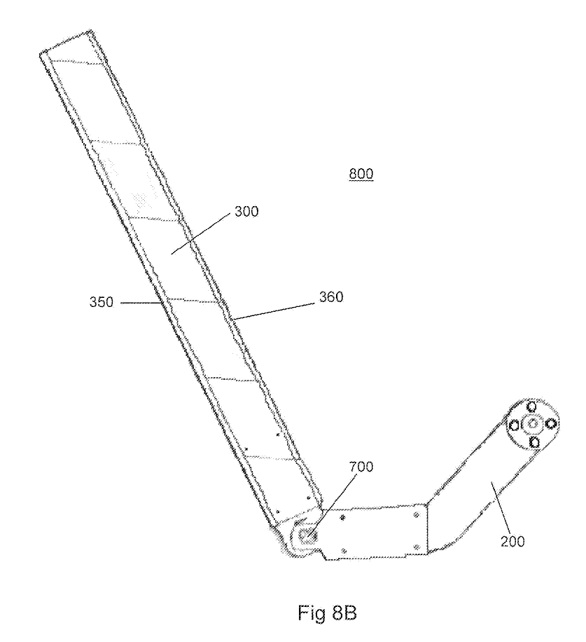

FIG. 8A shows a pedestrian gate 800 that has been fully lowered by the gate mechanism 150 according to an embodiment of the invention. The pedestrian arm 300 in its lowered position may extend over a pedestrian path at a height low enough to obstruct traffic. When no force is being applied to the lower side 350 of the pedestrian arm 300 (or when no pulling force is being applied to the upper side 360), the hinge 400 may have a maximum open angle (180 degrees in the example of FIG. 8A). The pedestrian arm 300 may be held in place such that the hinge 400 does not exceed its maximum open angle by the edge 760 blocking the progress of the tab 740.

FIG. 8B shows a pedestrian gate 800 that has been fully lowered by the gate mechanism 150 according to an embodiment of the invention. In FIG. 8B, a force is being applied (or has recently been applied) to the lower side 350 (or the upper side 360) of the pedestrian arm 300. This force may be a pedestrian lifting the gate, an obstacle standing in the way of the gate, or some other force. This force may cause the hinge 400 to rotate and the pedestrian arm 300 to raise. Because the hinge 400 rotates in response to this force, the pedestrian gate support arm 200 may retain its position in spite of the application of the force. Note that the pedestrian gate support arm 200 is in the same position in both FIGS. 8A and 8B, while the pedestrian arm 300 is in a different position in each figure. When a force is applied to the pedestrian arm 300, the pedestrian arm 300 may be raised without affecting the pedestrian gate support arm 200 at least until the edge 760 blocks the progress of the tab 740.

When the force applied in FIG. 8B is removed, the pedestrian arm 300 may return to its position in FIG. 8A. The friction brake 700 may slow the return of the pedestrian arm 300 to its lowering, raising, or lowered position corresponding with the position of the pedestrian gate support arm 200 and fully open hinge 400. Friction between friction pads 730 and 731 may counteract the force of gravity to reduce the acceleration rate of the pedestrian arm 300. By slowing the return of the pedestrian arm 300, injury or damage to a pedestrian or object under the pedestrian arm 300 may be minimized or prevented.

In some embodiments of the invention, some or all of the components of the pedestrian gate release may be made of materials which resist corrosion and/or wear. The components may also be constructed such that the device may be operable in varying and extreme weather and temperature conditions. For example, components may be used which operate during severe temperature conditions from −40 degrees Celsius to +71 degrees Celsius, with no humidity restrictions. Components may comply with other suitable temperature and humidity requirements as conditions at installation sites may dictate. Components may be manufactured such that they do not collect water either individually or when assembled into a complete pedestrian gate release. In some embodiments, all surface edges on the pedestrian gate release may be free of burrs and sharp edges that may cause injury or damage.

In some embodiments of the invention, an alarm or alarms may be added. These alarms may be triggered when the pedestrian arm 300 is lifted by a force. For example, audio alarms, strobe lights, or other indicators may be used as alarms. Audio or visual alarms may also be provided to indicate that the pedestrian arm 300 has been lifted by public authorities or because of special safety or environmental conditions. Surveillance cameras may be installed on or near the railroad crossing gate 100 to monitor the pedestrian arm 300. The pedestrian gate 140 may also be provided with flashing lights to indicate the approach of a train. The pedestrian gate release may be equipped with warning labels to alert pedestrians of the danger of potential retraction of the pedestrian arm 300 back to its normal position after being lifted, labels specifying maximum recommended gate lengths, and/or other labels.

The AREMA Manual For Railway Engineering 2010 is incorporated by reference in its entirety herein. Some embodiments of the invention may adhere fully with the AREMA Manual For Railway Engineering 2010 Part 3.2.23: Recommended Functional/Operational Guidelines for Self-Restoring Highway Rail Grade Crossing Gate Arm Devices. Fasteners, materials, and coatings used in embodiments of the invention may conform to guidelines specified in the AREMA Manual (for example, Part 1.5.10: Recommended Instructions for Painting and Protective Coatings; Part 14.6.20: Recommended Design Criteria for Bolts, Nuts, and Threads; Part 14.6.21: Recommended Design Criteria for Plain and Spring Lock Washers; Part 15.1.4: Recommended Developmental Criteria for Various Types of Steel; and/or Part 15.1.5: Recommended Developmental Criteria for Various Types of Non-Ferrous Metal and Alloys). When a pedestrian gate 140 is in its raised position, embodiments of the invention may allow it to withstand the wind forces specified in the AREMA Manual Section 3: Highway Rail Grade Crossing Warning Systems.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above-described embodiments.

In addition, it should be understood that any figures which highlight the functionality and advantages, are presented for example purposes only. The disclosed methodology and system are each sufficiently flexible and configurable, such that it may be utilized in ways other than that shown.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope of the present invention in any way.

It should also be noted that the terms “a”, “an”, “the”, “said”, etc. signify “at least one” or “the at least one” in the specification, claims and drawings.

Finally, it is the applicant's intent that only claims that include the express language “means for” or “step for” be interpreted under 35 U.S.C. §112, paragraph 6. Claims that do not expressly include the phrase “means for” or “step for” are not to be interpreted under 35 U.S.C. §112, paragraph 6.

What is claimed is:

1. A device for permitting independent movement of a railroad crossing pedestrian arm, comprising:
a hinge including a first end operable to be connected to a pedestrian gate support arm and a second end operable to be connected to a pedestrian arm;
wherein the hinge permits the second end to be moveable by an external force relative to a position of the first end, and wherein the hinge is configured such that the hinge pivots to allow the pedestrian arm to be raised when the first end is connected to a pedestrian gate arm support and the second end is connected to a pedestrian arm.

2. The device of claim 1, further comprising a brake mechanism operable to slow the movement of the hinge in at least one direction.

3. The device of claim 2, wherein the brake mechanism is operable to be connected to the first end of the hinge and the second end of the hinge.

4. The device of claim 2, wherein the brake mechanism comprises:
a hydraulic cylinder including a cylinder body and a piston rod;
a first bracket attached to the piston rod and the first end of the hinge; and
a second bracket attached to the cylinder body and the second end of the hinge.

5. The device of claim 2, wherein the brake mechanism comprises:
a first friction pad attached to the first end of the hinge; and
a second friction pad attached to the second end of the hinge;
wherein the first friction pad contacts the second friction pad.

6. The device of claim 1, further comprising an alarm operable to indicate that the second end of the hinge has been moved by an external force.

7. A railroad crossing gate comprising:
a pedestrian gate support arm operable to be connected to a gate motor for raising and lowering the pedestrian gate support arm;
a pedestrian arm; and
a hinge including a first end attached to the pedestrian gate support arm and a second end attached to the pedestrian arm;
wherein the hinge pivots to allow the pedestrian arm to be raised upon an application of an external force.

8. The railroad crossing gate of claim 7, further comprising a brake mechanism operable to slow the movement of the hinge in at least one direction.

9. The railroad crossing gate of claim 8, wherein the brake mechanism comprises:
a hydraulic cylinder including a cylinder body and a piston rod;
a first bracket attached to the piston rod and the first end of the hinge and/or the pedestrian gate support arm; and
a second bracket attached to the cylinder body and the second end of the hinge and/or the pedestrian arm.

10. The railroad crossing gate of claim 8, wherein the brake mechanism comprises:
a first friction pad attached to the first end of the hinge and/or the pedestrian gate support arm; and
a second friction pad attached to the second end of the hinge and/or the pedestrian arm;
wherein the first friction pad contacts the second friction pad.

11. The railroad crossing gate of claim 7, further comprising an alarm operable to indicate that the second end of the hinge has been moved by an external force.

12. The railroad crossing gate of claim 7, further comprising:
a gate motor connected to the pedestrian gate support arm;
wherein the gate motor is operable to raise and lower the pedestrian gate support arm.

13. The railroad crossing gate of claim 12, wherein the gate motor is operable to raise and lower at least one roadway gate support arm.

14. A method for permitting the independent movement of a railroad crossing pedestrian arm, comprising:
connecting a pedestrian arm to a pedestrian gate support arm using a hinge;
wherein the hinge is connected to the pedestrian gate support arm at a first end of the hinge and the pedestrian arm at a second end of the hinge such that the pedestrian arm is moveable via pivoting of the hinge to a raised position upon application of an external force.

15. The method of claim 14, further comprising disconnecting the pedestrian arm and the pedestrian gate support arm when the pedestrian arm is attached directly to the pedestrian gate support arm.

16. The method of claim 14, further comprising:
connecting a first bracket to the first end of the hinge and/or the pedestrian gate support arm; and
connecting a second bracket to the second end of the hinge and/or the pedestrian arm;
wherein the first bracket is attached to a piston rod of a hydraulic cylinder of a brake mechanism;
wherein the second bracket is attached to a cylinder body of the hydraulic cylinder of the brake mechanism; and
wherein the brake mechanism is operable to slow the movement of the hinge in at least one direction.

17. The method of claim 14, further comprising:
connecting a first friction pad of a brake mechanism to the first end of the hinge and/or the pedestrian gate support arm; and
connecting a second friction pad of a brake mechanism to the second end of the hinge and/or the pedestrian arm;
wherein the first friction pad contacts the second friction pad; and
wherein the brake mechanism is operable to slow the movement of the hinge in at least one direction.

18. The method of claim 14, further comprising connecting the pedestrian gate support arm to a gate motor operable to raise and lower the pedestrian gate support arm.

19. The method of claim 18, wherein the gate motor is operable to raise and lower at least one roadway gate support arm.
